(19) United States
(12) Patent Application Publication
(10) Pub. No.: US 2023/0249798 A1
(43) Pub. Date: Aug. 10, 2023

(54) SHOCK ABSORBER AND PROTECTION DEVICE AND METHOD FOR A PART OF AN AIRCRAFT DURING A SKIDDING PHASE

(71) Applicant: Airbus Operations (S.A.S.), Toulouse (FR)

(72) Inventor: Jérôme Milliere, Toulouse (FR)

(21) Appl. No.: 18/163,399

(22) Filed: Feb. 2, 2023

(30) Foreign Application Priority Data
Feb. 4, 2022 (FR) 2201005

(51) Int. Cl. B64C 1/06; F16F 7/12

(52) U.S. Cl. CPC B64C 1/062; F16F 7/12

(57) ABSTRACT

A skidding phase shock absorber and protection device to protect a part on an aircraft for example at the level of a fuel tank of the aircraft includes a support and a convex plate to assume a first position and a second position and to in the first position, because of the action of compression forces, undergo resisted plastic deformation via an elastic element and in a second position to withstand friction, the device assuring, during a crash landing of the aircraft with an impact phase followed by a skidding phase, both protection against the compression forces generated during the impact phase, via the plastic deformation and the elastic shock absorption, and mechanical protection and protection against heating during the skidding phase.

### TECHNICAL FIELD

The disclosure herein concerns a shock absorber and protection device and method for a part of an aircraft during a phase of skidding on the ground, in particular for the fuel tank of the aircraft situated in a lower part of the fuselage of the aircraft.

### BACKGROUND

This skidding phase shock absorber and protection device is intended to protect a part of the aircraft during a crash landing of the aircraft.

It is known that during a crash landing of this kind the impact of the aircraft on the ground generates a compression force loading the fuselage of the aircraft at least along its vertical axis. In a situation of this kind the lower part of the fuselage is generally the first zone of the aircraft to be subjected to impacts and therefore participates in the absorption of the energy of the impact. The structure of the fuselage including various structural elements (frames, crossmembers, . . . ) enables some of the impact energy to be absorbed, in particular when these structural elements are made of metal.

However, to improve the protection of the fuselage in the event of an impact of this kind it is known to provide systems to assist with absorbing the energy dissipated by the compression force generated on impact.

In particular, from the document EP2257465 B1 there is known a primary structure of an aircraft fuselage including at least one energy absorber structural element provided with a compression beam. This energy absorber element is intended to support the requirements for crash resistance, in particular in a vertical crash, more particularly for an aircraft including primary structures including composite material structural elements.

Moreover, from the document U.S. Pat. No. 5,542,626 A there is known an energy absorbing structural unit applied more particularly to a double decker aircraft. This structural unit, which is fixed under the belly part of the fuselage of the aircraft, is intended to absorb energy during a crash or an emergency landing.

The disclosure herein offers a new way of protection against a crash landing.

### SUMMARY

The disclosure herein concerns a skidding phase shock absorber and protection device for a part of an aircraft and in particular for a part of the fuselage of the aircraft at the level of the fuel tank.

To this end the device in accordance with the disclosure herein for absorbing shock and for protection during a skidding phase includes at least one support and a convex plate having a first end configured to be able to undergo plastic deformation and by which it is secured to the support and a free second end opposite the first end, the plate being adapted to assume a first position and a second position and to be moved from the first position to the second position, the plate being such that:
in the first position it is configured to be able to undergo plastic deformation at least at its first end connected to the support and its free second end is at a distance from the support with at least one elastic element between them;
for the passage from the first position to the second position it is configured by the action of compression forces acting in a first direction to undergo plastic deformation before producing resistance to the action by the elastic element; and
in the second position it is in contact with the support in at least one contact zone at a distance from the first end in such a manner as to acquire a stability enabling it to withstand friction in a second direction different from the first direction.

Accordingly, thanks to the disclosure herein and as explained further hereinafter there is obtained a skidding phase shock absorber and protection device that, during a crash landing comprising an impact phase followed by a skidding phase, provides both protection against the compression forces generated during the impact phase via plastic deformation and elastic shock absorption and protection against skidding, namely mechanical protection and limitation of transfer of heat as specified hereinafter.

The second direction is advantageously substantially orthogonal to the first direction.

Furthermore, in the second position a gap that is at least partly closed is advantageously formed between the first end and the contact zone.

In a preferred embodiment, the contact zone is located in at least one of the following locations:
at the free second end of the plate;
at a free end of a rod secured to the plate holding the spring in position.

Moreover, the (skidding phase shock absorber and protection) device advantageously includes at least one compression spring constituting the elastic element. The (skidding phase shock absorber and protection) device preferably includes at least one rod for holding the compression spring in position.

The disclosure herein also concerns a part of an aircraft, in particular a fuel tank of the aircraft, that includes at least one skidding phase shock absorber and protection device that is on an external face of the part of the aircraft.

The skidding phase shock absorber and protection device is advantageously on a structural element of the part of the aircraft.

In one particular embodiment the aircraft part includes a plurality of skidding phase shock absorber and protection devices distributed over a low peripheral portion of the part of the aircraft, longitudinally at the level of the structural element of the part of the aircraft.

Moreover, the aircraft part advantageously includes a plurality of shock absorbing zones offset longitudinally along the part of the aircraft, each of the shock absorber zones including at least one skidding phase shock absorber and protection device.

The disclosure herein also concerns an aircraft, in particular a commercial aircraft. According to the disclosure herein the aircraft includes at least one skidding phase shock absorber and protection device such as that described above and/or at least one aircraft part such as that described above.

The disclosure herein further concerns a skidding phase shock absorbing and protection method applied to a part of an aircraft by at least one skidding phase shock absorber and protection device as described hereinabove.

According to the disclosure herein the skidding phase shock absorbing and protection method comprises in succession during an impact phase producing compression forces in a first direction followed by a skidding phase in a second direction different from the first direction:
a step of absorbing energy in reaction to the action of the compression forces, the step of absorbing energy comprising in succession:
a sub-step of plastic deformation during which the plate undergoes plastic deformation; and
a sub-step of resistance to the action by the elastic element; and
a step of protection against friction produced by skidding in the second direction by the plate that is in contact with the support in the contact zone.

### BRIEF DESCRIPTION OF THE DRAWINGS

The appended figures clearly explain how the disclosure herein can be implemented. In these figures identical references designate similar elements.

FIG. 1 is a diagrammatic cross-section taken along a section line A-A in FIG. 2 of one particular embodiment of a skidding phase shock absorber and protection device.

FIG. 2 is a diagrammatic view as seen from below of the skidding phase shock absorber and protection device from FIG. 1.

FIG. 3 is a diagrammatic view of an aircraft provided with at least one skidding phase shock absorber and protection device, illustrating successive phases during a crash landing of the aircraft.

FIG. 4 is a diagrammatic cross-section of part of a skidding phase shock absorber and protection device in a first position.

FIG. 5 is a section similar to that of FIG. 4 in a second position.

FIG. 6 is a block diagram of a skidding phase shock absorbing and protection method.

FIG. 7 is a schematic view of an aircraft part provided with a plurality of skidding phase shock absorber and protection devices.

FIG. 8 is a diagrammatic cross-section of the aircraft part from FIG. 7.

### DETAILED DESCRIPTION

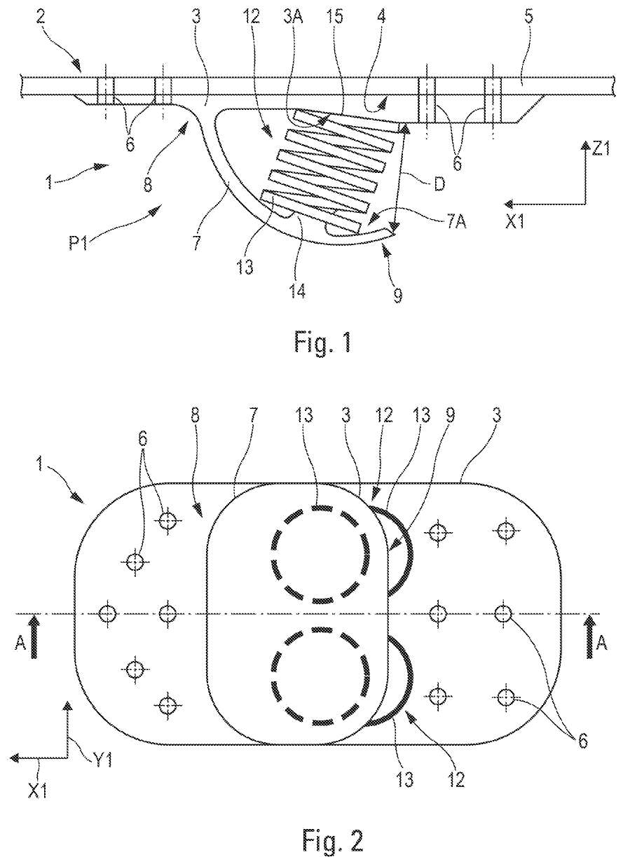

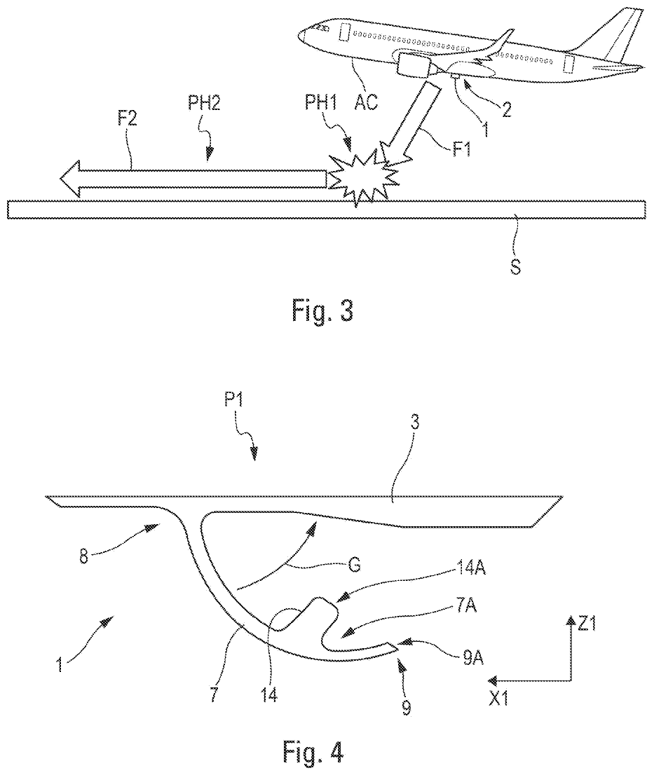

The skidding phase shock absorber and protection device 1 (hereinafter the “device”) represented schematically in one particular embodiment in FIGS. 1 and 2 and enabling illustration of the disclosure herein is intended to be mounted on a part 2 of an aircraft AC, in particular of a commercial aircraft, as represented in FIG. 3.

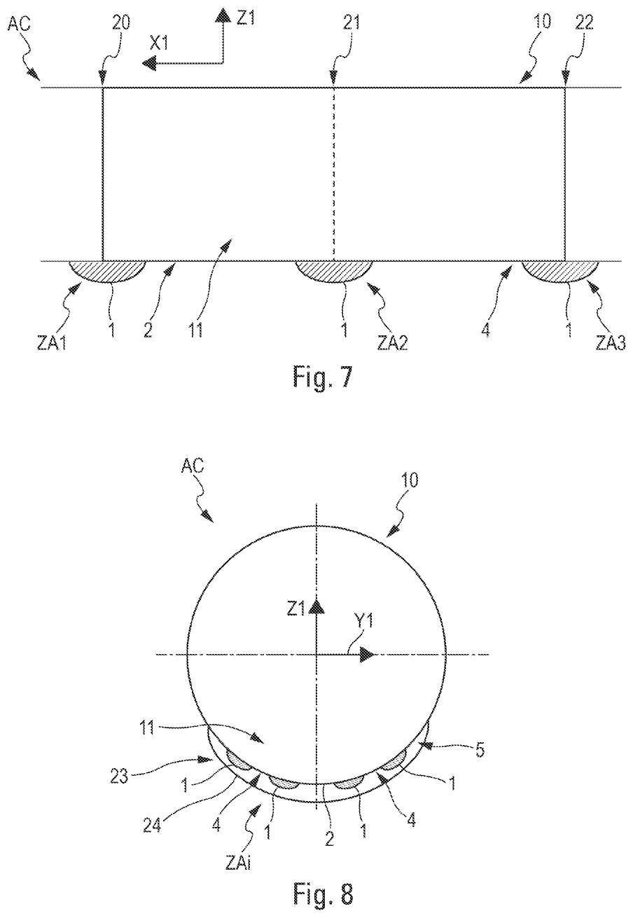

In one preferred but non-limiting embodiment the part 2 of the aircraft AC which is intended to receive the device 1 is a part of the fuselage 10 of the aircraft AC, in particular at the level of a fuel tank 11, as explained hereinafter with reference to FIGS. 7 and 8.

The device 1 is more particularly intended to protect the aircraft AC during a crash landing as shown by way of illustration in FIG. 3. This crash landing, which occurs after descent of the aircraft AC as illustrated by an arrow F1 in this FIG. 3, comprises a phase PH1 of impact with the ground S (mainly generating vertical compression forces) that is followed by a phase PH2 of skidding (forward) of the aircraft AC on the ground as illustrated by an arrow F2.

The part 2 of the aircraft AC intended to receive the shock absorber device 1 may correspond to any part of the aircraft AC to be particularly protected during this kind of crash landing.

In the preferred embodiment represented in FIGS. 1 and 2 the device 1 includes a support 3 by which the device 1 is intended to be fixed to one face 4 of a structural element 5.

To this end the support 3 may include a plurality of holes 6 (of circular section) to receive fixing elements (not represented) such as bolts or rivets in particular. In the context of the disclosure herein using other fixing means that are usual for fixing the support 3 to the structural element 5 may equally be envisaged.

The structural element 5 may be a structural element of the fuselage 10 of the aircraft AC, as explained hereinafter with reference to FIG. 7. The face 4 of the structural element 5 corresponds in this case to an external face of the fuselage 10.

The support 3 is preferably produced in the form of a plane or curved plate. In one preferred embodiment the support 3 has, as represented in FIGS. 1 and 2, a shape adapted to the shape of the structural element 5 in such a manner as to allow surface to surface contact between these two elements.

In FIGS. 1 and 2 there has been represented a system of axes formed of X1, Y1 and Z1. The vectors X1 and Y1 define a plane corresponding to the plane of the support 3 if it has a plane shape or to the plane receiving the orthogonal projection of this support 3 if it has a curved shape. The vector Z1 is orthogonal to the plane X1Y1 and is directed from the support 3 toward the structural element 5.

The device 1 also includes a curved, namely convex, plate 7. This plate 7 has an end 8 by which it is secured to the support 3 and a free end 9 opposite the end 8.

The convex plate 7 may have in cross-section (as in FIG. 1) a circular arc shape with a constant radius of curvature or indeed any shape curvature.

The free end 9 of the plate 7 is at a distance D from the support 3, as represented in FIG. 1.

In one preferred embodiment the support 3 and the plate 7 are made in one piece, in particular as a metal part.

Moreover, the device 1 includes one or more elastic elements 12 arranged between a so-called internal face 7A of the plate 7, preferably in the vicinity of the free end 9, and a so-called external face 3A of the support 3. In the FIG. 2 example the device 1 includes two elastic elements 12.

In the context of the disclosure herein there may be envisaged for the elastic element any type of elastic means or member able to generate an elastic force between the internal face 7A of the plate 7 and the external face 3A of the support 3. Nevertheless, the elastic element 12 is preferably a spring and in particular a compression spring 13 as represented in FIG. 1. The compression spring 13 is a cylindrical coil spring that produces resistance to axial pressure. The spring effect enables it to produce resistance during its compression phase and therefore to absorb energy.

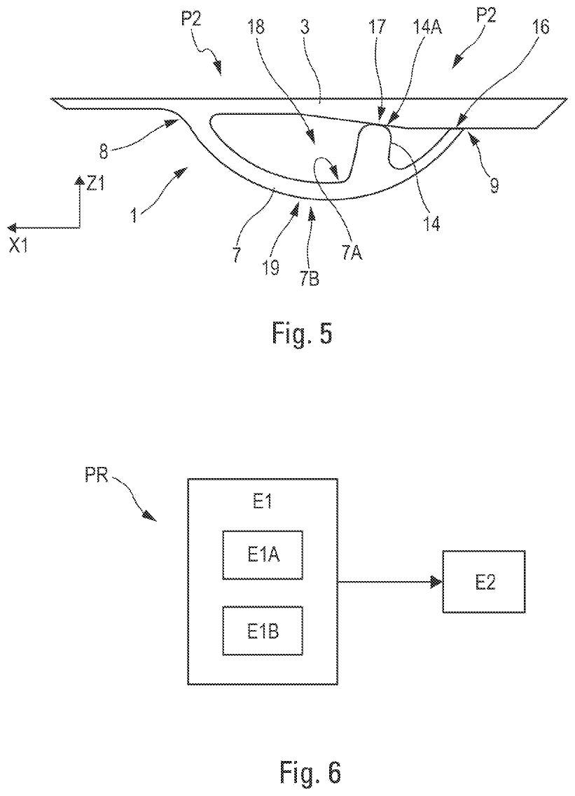

In one preferred embodiment the device 1 includes, associated with each compression spring 13, a rod 14 (clearly visible in FIGS. 4 and 5) that is surrounded by the compression spring 13.

In one particular embodiment the rod 14 is a cylinder projecting from the internal face 7A of the plate 7. This rod 14 is in particular intended to hold in place the compression spring 13 which surrounds it and also to orient its axial direction in an appropriate direction (depending in particular on the radius of curvature of the plate 7 at the level of the arrangement of the rod 14 and of the orientation of the compression forces to be absorbed).

In one particular embodiment the external face 3A of the support 3 includes a bevel 15 against which the compression spring 13 bears, as represented in FIG. 1. The inclination of the bevel 15 is adapted to the arrangement and to the characteristics of the compression spring 13.

In a variant (not shown) the rod may equally be on the external face 3A of the support 3.

In another variant (not represented), providing for a compression spring two opposed rods having the same direction, one of which is fixed to the internal face 7A of the plate 7 and the other of which is fixed to the external face 3A of the support 3, may also be envisaged.

As described hereinafter, the plate 7 of the device 1 is able to assume a first position P1 represented in FIGS. 1 and 4 and a second position P2 represented in FIG. 5, and can be moved from position P1 to position P2 as described below.

In FIGS. 4 and 5 the compression spring is not represented for reasons of clarity, although the device 1 represented in FIGS. 4 and 5 is similar to that from FIG. 1, provided with compression springs.

In position P1 (FIGS. 1 and 4) the plate 7 is configured to be able to undergo plastic (mechanical) deformation at its end 8 connected to the support 3 because of the action of compression forces acting in the direction of the vector Z1. To this end the plate 7 is preferably made of metal. Moreover, in position P1 the free end 9 of the plate 7 is at a distance from the support 3 with at least one elastic element 12 between them (FIG. 1).

Moreover, in position P2 (FIG. 5) the plate 7 is in contact with the support 3 in at least one contact zone 16, 17 that is at a distance from the end 8 (by which the plate 7 is secured to the support 3). The bearing of the plate 7 on the support 3 in the contact zone 16, 17 enables a transfer of force.

To be more precise, in this position P2 there also exists at least one two-fold connection between the support 3 and the plate 7, namely on the one hand the connection at the end 8 and on the other hand the contact in the contact zone 16, 17. Because of this two-fold (or greater) connection of the plate 7 to the support 3 the plate 7 has a stability enabling it to withstand friction in the direction of the vector X1 shown in FIG. 5.

In this position P2 the device 1 is essentially a skid able to withstand skidding of the part 2 while maintaining a minimum distance between the rubbing zone and the structure of the aircraft to be protected, thus enabling limitation of the heat transfer to that structure, as explained hereinafter.

The device 1 may include a single contact zone 16 or 17. Nevertheless, in one preferred embodiment, represented in FIG. 5, the device 1 in position P2 includes two contact zones 16 and 17 of the plate 7 with the support 3, namely:

the contact zone 16 that is located at the free end 9 of the plate 7; the edge 9A of the free end 9 of the plate 7 has a surface adapted to come into surface to surface contact with the support 3 in position P2; and

the contact zone 17 that is located at a free end 14A of the rod 14 holding the compression spring 13 in place.

These two contact zones 16 and 17 reinforce the stability of the device 1 in position P2.

The device 1 as described hereinabove is able to implement a skidding phase shock absorbing and protection method PR represented in FIG. 6. This method PR is executed during a crash landing of the aircraft AC (provided with the device 1) including an impact phase PH1 generating compression forces in a direction illustrated by the vector Z1 in FIG. 1 followed by a phase PH2 of skidding in a direction illustrated by the vector X1.

This method PR includes, in succession:

a step E1 of energy absorption by the device 1 in reaction to the action of the compression forces generated during the impact phase PH1 (FIG. 3), by the plate 7 which is located in position P1 at the moment of impact; and

a step E2 of protection against the friction generated by skidding during the skidding phase PH2 by the plate 7 that is located in the position P2 to implement this step E2.

The energy absorption step E1 comprises:

a sub-step E1A of plastic deformation during which, because of the action of the compression forces generated during the impact phase PH1, the plate 7 is subjected to plastic deformation from the position P1 (FIGS. 1 and 4), as illustrated by an arrow G in FIG. 4. By this plastic deformation, occurring mainly at the end 8, the plate 7 is bent toward the support 3 and absorbs energy; and

a sub-step E1B of resistance to the action of the compression forces by the elastic element or elements 12.

During this deformation in the direction illustrated by the arrow G the plate 7 bears on the compression spring or springs 13 (FIGS. 1 and 2) which resist(s) this action and thus absorb(s) energy in sub-step E1B.

As a function in particular of the characteristics of the elastic element or elements 12, this sub-step E1B may occur, at least in part, at the same time as the sub-step E1A, or it may occur after the sub-step E1A.

During step E1 the plate 7 goes from position P1 to position P2.

In the position P2 obtained at the end of step E1, as represented in FIG. 5, the plate 7 has a stability enabling it during the subsequent step E2 to withstand friction in the direction of the vector X1, like a skid. In particular, the plate 7 bearing on the support 3 in the contact zone 16, 17 enables a transfer of force.

Skidding entails contact of the plate 7 of the device 1 with the ground in a bottom skidding zone 19 of its external face 7B (FIG. 5).

In step E2 during the skidding phase PH2 the mechanical protection of the part 2 to be protected against skidding is provided by a plurality of devices 1. A ventral fairing 24 (FIG. 8) under the aircraft can also contribute to this protection. Moreover, providing other usual protection elements (not represented) in addition to the devices 1 may equally be envisaged.

Moreover, in this position P2 a gap 18 is formed between the support 3 and the plate 7, which are in contact with one another at the end 8 and in the contact zones 16 and 17. This gap 18 may be completely or partly closed.

The gap 18 created in this way limits the transfer of heat linked to skidding from the skidding zone 19 to the structural element 5. This feature is particularly advantageous if the structural element 5 forms part of a fuel tank such as the fuel tank 11 represented in FIGS. 7 and 8. In fact, in an application of this kind the gap 18 limits the transfer of heat generated by friction to the fuel tank and therefore reduces the risk of increasing the temperature of the fuel in the tank and consequently the risk of self-ignition of the fuel.

As described hereinabove each device 1 therefore has the advantage of being able, on its own, to provide a plurality of different functions, namely:

absorbing energy via plastic deformation in a first time period during the impact phase PH1 in sub-step E1A;

absorbing energy via the elastic element or elements 12 in a second time period during the impact phase PH1 in sub-step E1A; and

friction in step E2 in a third time period after the plastic deformation to protect the fuselage and in particular the fuel tank (mechanically and against excessive transfer of heat) during the phase PH2 of the fuselage sliding on the ground. The protection of the structure from friction is achieved thanks to the mechanical contact and the protection from heating created by this friction, by limiting the transfer of heat to the fuel tank, is achieved thanks to the gap 18 enabling dissipation of heat and limiting transfer of heat to the structure by conduction.

As indicated hereinabove, in a preferred but non-limiting application the part 2 of the aircraft AC that receives the shock absorber devices 1 is a part of the fuselage of the aircraft AC at the level of a fuel tank 11, as represented in FIGS. 7 and 8.

In this case the part 2 corresponds to the fuel tank 11, in particular a tank of rear centre tank (RCT) type formed by the skin of the fuselage. This part 2 of the fuselage is generally also protected at the bottom by a ventral fairing 24 FIG. 8), which may be made longer to cover all of the fuel tank 11.

In the particular embodiment from FIG. 7 the aircraft part 2 includes a plurality of shock absorbing zones ZA1, ZA2 and ZA3 offset longitudinally (in the direction X1) along the part 2. Each of these shock absorber zones ZAi (i being an integer between 1 and 3 inclusive in this example) is provided with a plurality of devices 1, as represented in FIG. 8 for any zone ZAi.

Each of the shock absorbing zones ZA1, ZA2 and ZA3 is under the part 2, in line with a respective structural element 20, 21, 22 of the part 2 as represented in FIG. 7. By way of illustration:

in this example the structural element 20 is a front baffle of the fuel tank 11;

the structural element 21 is a rigid frame; and

the structural element 22 is a rear baffle of the fuel tank 11.

To absorb the forces shock absorber devices 1 are positioned in line with the structural elements 20, 21 and 22.

To be more precise, as represented in FIG. 8, in each shock absorbing zone ZAi the aircraft part 2 includes a plurality of devices 1 on a bottom peripheral portion 23, longitudinally at the level of the corresponding structural element 20, 21, 22. In one particular embodiment the devices 1 are distributed regularly along this peripheral portion 23.

As indicated hereinabove, to implement the envisaged functions (absorbing energy and protection during skidding), the devices 1 may be combined with others of the usual shock absorber and/or protection means (not represented).

The devices 1 therefore enable adequate protection to be provided for the aforementioned two phases PH1 and PH2 during a crash landing of the aircraft AC, by enabling:

in phase PH1, absorbing energy to assure absence of rupture of the part 2 to be protected and, moreover, absence of leakage if the part 2 is to a fuel tank 11; and

in phase PH2, withstanding friction forces during skidding of the aircraft AC forward on the ground in such a manner as to assure absence of rupture of the part 2 and equally absence of leakage when the part 2 is a fuel tank 11. Moreover, in this phase PH2 the gap 18 created limits the transfer to the fuel tank 11 of heat linked to friction, thus limiting the risk of increasing the temperature of the fuel in the fuel tank 11 and consequently the risk of auto-ignition of the fuel.

Each of the devices 1 also has the advantage that, after being subjected to the forces of phase PH1 and in particular to compression forces, it remains operational and is in a position to perform its functions in the following phase PH2.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A skidding phase shock absorber and protection device for a part of an aircraft,
comprising at least one support and a convex plate having a first end configured to undergo plastic deformation and by which it is secured to the support and a free second end opposite the first end, the plate being configured to assume a first position and a second position and to be moved from the first position to the second position, the plate being such that:
in the first position it is configured to undergo plastic deformation at least at its first end connected to the support and its free second end is at a distance from the support with at least one elastic element between them;
for passage from the first position to the second position it is configured by an action of compression forces acting in a first direction to undergo plastic deformation before producing resistance to action by the elastic element; and
in the second position it is in contact with the support in at least one contact zone at a distance from the first end to acquire a stability enabling it to withstand friction in a second direction different from the first direction.

2. The device according to claim 1, wherein the second direction is substantially orthogonal to the first direction.

3. The device according to claim 1, wherein in the second position a gap that is at least partly closed is formed between the first end and the contact zone.

4. The device according to claim 1, wherein the contact zone is located in at least one of:
at the free second end of the plate;
at a free end of a rod secured to the plate holding the spring in position.

5. The device according to claim 1, comprising at least one compression spring constituting the elastic element.

6. The device according to claim 5, comprising at least one rod for holding the compression spring in position.

7. A part of an aircraft or of a fuel tank of an aircraft, comprising at least one skidding phase shock absorber and protection device according to claim 1 on an external face of the part of the aircraft or the fuel tank of the aircraft.

8. The aircraft part or fuel tank part according to claim 7, wherein the skidding phase shock absorber and protection device is on a structural element of the part of the aircraft or the fuel tank of the aircraft.

9. The aircraft part or fuel tank part according to claim 8, comprising a plurality of skidding phase shock absorber and protection devices distributed over a low peripheral portion of the part of the aircraft or the fuel tank, longitudinally at a level of the structural element of the part of the aircraft or the fuel tank.

10. The aircraft part or fuel tank part according to claim 7, comprising a plurality of shock absorbing zones offset longitudinally along the part of the aircraft or the fuel tank, each of the shock absorbing zones including at least one skidding phase shock absorber and protection device.

11. An aircraft, comprising at least a part of an aircraft or a fuel tank or an aircraft according to claim 7.

12. An aircraft, comprising at least one skidding phase shock absorber and protection device according to claim 1.

13. A skidding phase shock absorbing and protection method for a part of an aircraft by at least one skidding phase shock absorber and protection device according to claim 1, comprising in succession during an impact phase producing compression forces in a first direction followed by a skidding phase in a second direction different from the first direction:
a step of absorbing energy in reaction to action of the compression forces, the step of absorbing energy comprising in succession:
a sub-step of plastic deformation during which the plate undergoes plastic deformation; and
a sub-step of resistance to the action by the elastic element; and
a step of protection against friction produced by skidding in the second direction by the plate that is in contact with the support in the contact zone.
